(19) United States
(12) Patent Application Publication
(10) Pub. No.: US 2003/0057832 A1
(43) Pub. Date: Mar. 27, 2003

(54) Plasma picture screen with increased efficiency

(76) Inventors: Thomas Juestel, Aachen (DE); Gero Heusler, Aachen (DE); Markus Heinrich Klein, Aachen (DE)

Correspondence Address: U.S. Philips Corporation, 580 White Plains Road, Tarrytown, NY, 10591, US

(21) Appl. No.: 10/247,198

(22) Filed: Sep. 19, 2002

(30) Foreign Application Priority Data
Sep. 22, 2001 (DE) 10146798.2

(51) Int. Cl. H01J 17/49

(52) U.S. Cl. 313/587

(57) ABSTRACT

The invention relates to a plasma picture screen in which the luminescent materials for the generation of visible light are applied to the front plate (1) or to the front plate (1) and the carrier plate (2).

The invention relates to a plasma picture screen provided with a front plate comprising a transparent plate on which a first dielectric layer and a first protective layer are applied, with a carrier plate, with a ribbed structure which divides the area between the front plate and the carrier plate into plasma cells which are filled with a gas, and with one or more electrode arrays on the front plate and the carrier plate for the generation of corona discharges in the plasma cells, whereby UV light with a wavelength of >172 nm is generated.

Plasma picture screens render possible color pictures with high resolution and large screen diagonals and have a compact design. A plasma picture screen has a hermetically sealed cell which is filled with a gas, with electrodes in a grid-type arrangement. The application of an electrical voltage causes a gas discharge which generates light in the ultraviolet range. By means of luminescent materials, this light may be converted into visible light and emitted through the front plate of the cell to the viewer.

In principle, two types of plasma picture screens are distinguished: a matrix arrangement of the electrodes and a coplanar arrangement of the electrodes. With the matrix arrangement, the gas discharge is ignited and maintained at the point of intersection of two electrodes on the front and carrier plate. With the coplanar arrangement of the electrodes, the gas discharge is maintained between the electrodes on the front plate and is ignited at the point of intersection with an electrode, a so-called address electrode, on the back plate. In this case, the address electrode is located under the layer of fluorescent material.

In a typical AC plasma picture screen, the front plate has a protective layer of MgO. MgO has a high ion-induced secondary electron emission coefficient and hence reduces the ignition voltage of the gas.

Usually, a xenon-containing gas is used in plasma picture screens, which generates light in the VUV (vacuum ultraviolet) wavelength range in a plasma discharge. The drawback is that MgO absorbs in the VUV wavelength range.

With the coplanar arrangement of the electrodes, approximately half of the VUV light generated during the gas discharge reaches the front plate, where it is absorbed in the layers there. For one part of the VUV light, this effect is further intensified as the VUV light is re-absorbed in the gas area by gas atoms being excited from their normal condition into an energetically higher condition. Although the light is then re-emitted, it is diverted from its original direction, so that light which was originally propagated in the direction of the fluorescent layer is also able to reach the front plate.

Another drawback of a plasma cell design of this kind is the fact that, due to the different luminescent materials coating the address electrodes, different interactions between plasma and luminescent material, and hence different addressing voltages occur for the different plasma cells. This restricts the electrical margins within which the plasma picture screen may be operated.

It is therefore an object of the invention to provide an improved plasma picture screen.

The object is achieved by a plasma picture screen provided with a front plate comprising a transparent plate on which a first dielectric layer and a first protective layer are applied, with a carrier plate, with a ribbed structure which divides the area between the front plate and the carrier plate into plasma cells which are filled with a gas, and with one or more electrode arrays on the front plate and the carrier plate for the generation of corona discharges in the plasma cells, whereby UV light with a wavelength of >172 nm is generated, wherein the front plate has a first layer containing a luminescent material on the side facing the plasma cells.

A plasma picture screen of this kind has the advantage that no interactions between plasma and luminescent material take place, because the layer containing a luminescent material is no longer located in the plasma cells, i.e. is no longer between the front plate and the carrier plate. As a result, the electrical margins within which the plasma picture screen can be operated are wider.

Advantageous embodiments are described in the dependent claims.

The incorporation of luminescent materials in the first dielectric layer or in the first protective layer produces a first layer containing a luminescent material on the front plate in a simple manner.

It may be advantageous for the layer containing a luminescent material to be an additional layer.

In another advantageous embodiment, the efficiency of a plasma picture screen is increased by the carrier plate additionally having a second layer containing a luminescent material. In this way, the UV light generated in the plasma discharge may be absorbed by luminescent materials on the front plate and by luminescent materials on the carrier plate. This second layer containing a luminescent material may be a second dielectric layer, an additional layer, or a second protective layer.

The invention will be further described with reference to six Figures, in which:

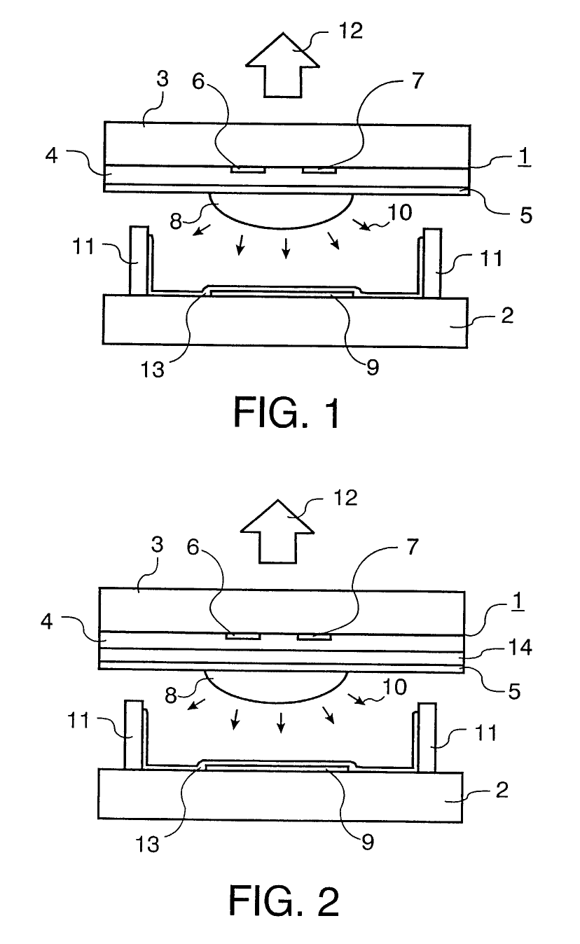

FIGS. 1 to 6 each show the structure and operating principle of an individual plasma cell in an AC plasma picture screen.

According to FIG. 1, a plasma cell in an AC plasma picture screen with a coplanar arrangement of the electrodes has a front plate 1 and a carrier plate 2. The front plate 1 comprises a transparent plate 3, for example made of glass, on which a first dielectric layer 4 and on this a first protective layer 5, which preferably contains MgO, are located. Applied to the transparent plate 3 are parallel, strip-type discharge electrodes 6, 7 which are covered by the first dielectric layer 4. The discharge electrodes 6, 7 are for example made of metal, ITO, or a combination of a metal and ITO. The carrier plate 2 is preferably made of glass and applied to the carrier plate 2 are parallel, strip-type address electrodes 9 made, for example, of Ag and running perpendicularly to the discharge electrodes 6, 7. Individually controllable plasma cells, in which corona discharges take place, are formed as a result of a ribbed structure 11 with separating ribs preferably made of a dielectric material.

In the plasma cell and between the discharge electrodes 6, 7, which function as a cathode and an anode respectively, there is a gas which emits radiation 10 in the case of a plasma discharge 10. After ignition of the surface discharge, which may result in charges flowing along a discharge path lying between the discharge electrodes 6, 7 in the plasma region 8, a plasma forms in the plasma region 8, by which, depending upon the composition of the gas, radiation 10 is generated with the maximum of the emitted wavelength being >172 nm. Preferably, during the plasma discharge, radiation 10 in a wavelength range of between 200 and 350 nm is generated. The gas may be, for example, nitrogen, a mixture of nitrogen and at least one rare gas, such as, for example, He, Ne, Ar, Kr or Xe, or a rare gas halide. The radiation 10 excites the first layer containing a luminescent material into radiation, which layer then emits visible light 12 which exits through the front plate 1 and hence represents a luminous point on the screen. The first layer containing a luminescent material is divided into several color segments. Normally, the red-, green- or blue-emitting color segments of the first layer containing a luminescent material are applied in the form of vertical stripe triplets. A plasma cell with a color segment forms a so-called subpixel. Three adjacent plasma cells each with a red-, green- or blue-emitting color segment together form a pixel or picture element.

It is advantageous for the first layer containing a luminescent material to be applied to the front plate in such a way that no interactions between luminescent material and plasma occur. In this embodiment, the luminescent materials are introduced into the first dielectric layer 4, which thus forms the first layer containing a luminescent material.

The use of UV light instead of high-energy VUV light for the generation of visible light has the advantage that, in particular with oxidic luminescent materials, there is no band excitation of the luminescent materials. This means that no photo-ionization processes, which lead to a reduced efficiency of the luminescent materials, take place. Another advantage is that, unlike VUV light, UV light is not absorbed by MgO. Also advantageous is the fact that the Stokes shift is much lower in the conversion from UV light into visible light, and the plasma picture screen has a better luminous efficacy at the same plasma efficiency.

Preferably, a reflecting layer 13, which reflects UV light and/or visible light, is applied to the carrier plate 2 and the address electrode 9 in this embodiment. The reflecting layer 13 may contain a reflecting dielectric material or a scattering, dielectric material.

Alternatively, the luminescent materials may be introduced into the first protective layer 5, which then forms the first layer containing a luminescent material.

FIG. 2 shows another possible embodiment of a plasma cell for an AC plasma picture screen with a coplanar arrangement of the electrodes. In this embodiment, the first layer containing a luminescent material is formed by an additional layer 14 located between the first protective layer 5 and the first dielectric layer 4. A reflecting layer 13, which reflects UV light and/or visible light, may be applied to the carrier plate 2 and the address electrode 9. Alternatively, the additional layer 14 may be located between the transparent plate 3 and the first dielectric layer 4.

Advantageous with the embodiments according to FIG. 1 and FIG. 2 is the fact that uniform plasma cells with the same properties are obtained because there are no interactions between the luminescent material and the plasma. This means that the electrical margins within which the plasma picture screen may be operated are wider.

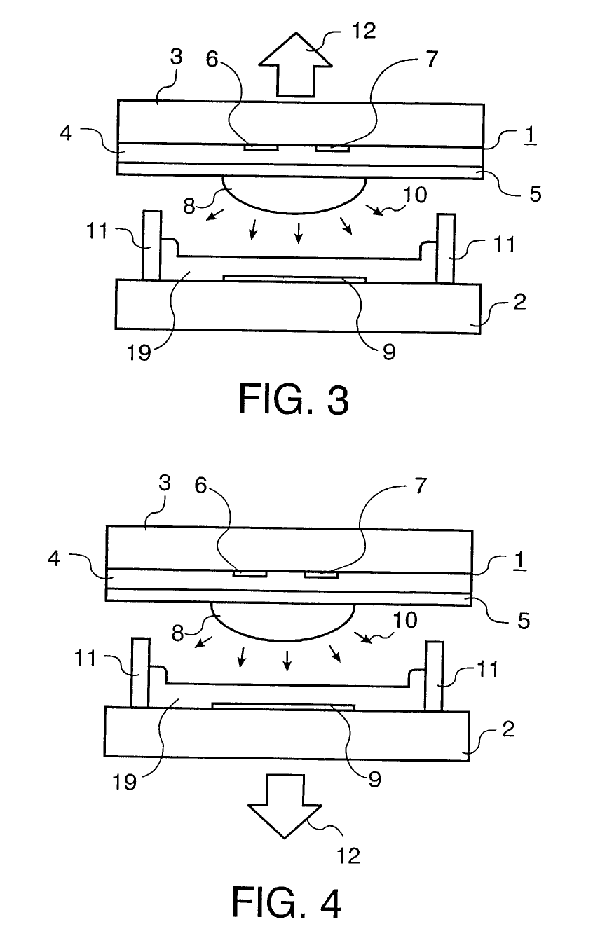

FIG. 3 shows a plasma picture screen with a coplanar arrangement of the electrodes, which, in addition to the first layer containing a luminescent material on the front plate 1, has a second layer containing a luminescent material on the carrier plate 2. In this embodiment, the first dielectric layer 4 contains luminescent materials and forms the first layer containing a luminescent material. The second layer containing a luminescent material is an additional layer 19 and covers the address electrodes 9. As with the first layer containing a luminescent material, it is divided into color segments. Here, the blue color segments in the second layer containing a luminescent material lie opposite the blue color segments in the first layer containing a luminescent material, the red color segments in the second layer containing a luminescent material lie opposite the red color segments in the first layer containing a luminescent material and the green color segments in the second layer containing a luminescent material lie opposite the green color segments in the first layer containing a luminescent material. With this arrangement approximately a half of the radiation 10 generated in the plasma discharge radiation 10 goes to the first layer containing a luminescent material on the front plate 1 and approximately the other half goes to the second layer containing a luminescent material on the carrier plate 2. This leads to an increase in the efficiency of the plasma picture screen because, in contrast to conventional plasma picture screens with a coplanar arrangement of the electrodes, the UV light generated in the plasma discharge and emitted in the direction of the front plate 1 is not absorbed by the layers to the exclusion of emission of visible light here.

Preferably, a reflecting layer 13, which reflects visible light, is applied between the carrier plate 2 and the second layer containing a luminescent material.

FIG. 4 shows a plasma picture screen in which, unlike with the plasma picture screen shown in FIG. 3, the light emission takes place not via the front plate 1, but through the carrier plate 2. A reflecting layer 13, which reflects visible light, is preferably inserted between the transparent plate 3 and the first layer containing a luminescent material in this embodiment. In addition, the address electrodes 9 are advantageously partially made of a transparent material, such as ITO, for example.

In the embodiments according to FIG. 3 and FIG. 4, the first layer containing a luminescent material may alternatively be formed by the additional layer 14 or the first protective layer 5.

The carrier plates 2 in FIGS. 1 to 4 have been rotated 90 in the representation.

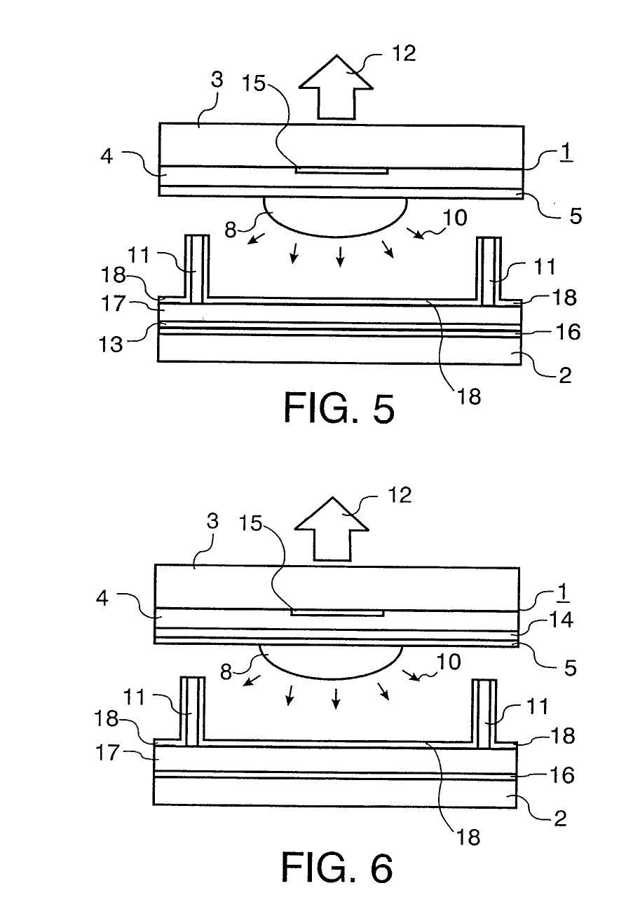

FIG. 5 shows the plasma cell of an AC plasma picture screen with a matrix arrangement of the electrodes. This plasma cell also has a front plate 1 and a carrier plate 2. The front plate 1 comprises a transparent plate 3, for example made of glass, on which is located a first dielectric layer 4 and on this a first protective layer 5, which preferably comprises MgO. In this embodiment, the luminescent materials are introduced into the first dielectric layer 4, which thus forms the first layer containing a luminescent material. A first set of parallel strip electrodes 15 is applied to the transparent plate 3. The carrier plate 2 is preferably made of glass, and a second set of parallel, strip electrodes 16, which runs vertically to the first set of electrodes 15, is applied to the carrier plate 2. The second set of electrodes 16 and the intermediate areas of the carrier plate 2 may be covered with a reflecting layer 13 which reflects UV light and/or visible light. A second dielectric layer 17 is applied to the electrode 16 in the second set of electrodes. In this embodiment, it may be advantageous for the separating ribs 11 and the second dielectric layer 17 to be covered with a second protective layer 18, which preferably comprises MgO.

It is also possible for the first protective layer 5, instead of the first dielectric layer 4, to form the first layer containing a luminescent material.

Alternatively, a second layer containing a luminescent material may also be applied to the carrier plate 2. This may be, for example, the second dielectric layer 17, the second protective layer 18, or an additional layer 19. With a plasma picture screen with a matrix arrangement of the electrodes 15, 16, the additional layer 19 may be located, for example, between the electrodes 16 in the second set of electrodes and the second dielectric layer 17 or between the second dielectric layer 17 and the second protective layer 18.

With a matrix arrangement of the electrodes 15, 16, the plasma discharge is ignited and maintained at the point of intersection between an electrode 15 of the first set of electrodes and an electrode 16 of the second set of electrodes. The gas used for the plasma discharge preferably has the same composition as that described above for a plasma picture screen with a coplanar arrangement of the electrodes.

FIG. 6 shows a plasma picture screen with a matrix arrangement of the electrodes in which the first layer containing a luminescent material is formed by an additional layer 14 between the first dielectric layer 4 and the first protective layer 5.

Alternatively, the carrier plate 2 may have a second layer containing a luminescent material, which may be formed by the second protective layer 18, the second dielectric layer 17, or an additional layer 19. The electrodes 16 in the second set of electrodes and the intermediate areas of the carrier plate 2 may also be covered with a reflecting layer 13 which reflects UV light and/or visible light.

It is advantageous, in the embodiments according to FIG. 5 and FIG. 6 that uniform plasma cells with the same properties are obtained, since no interactions occur between luminescent material and plasma. This means that the electrical margins within which the plasma picture screen may be operated are wider. In addition, the efficiency of the plasma picture screen may be increased by the application of luminescent materials on the front plate 1 and the carrier plate 2.

In a plasma picture screen with a matrix arrangement of the electrodes, the first layer containing a luminescent material and the second layer containing a luminescent material may again be divided into color segments. Here, the blue color segments in the second layer containing a luminescent material lie opposite the blue color segments in the first layer containing a luminescent material, the red color segments in the second layer containing a luminescent material lie opposite the red color segments in the first layer containing a luminescent material and the green color segments in the second layer containing a luminescent material lie opposite the green color segments in the first layer containing a luminescent material.

In all the examples of embodiments, the following may be used as a luminescent material for blue color segments, for example: (Sr₁₋ₓMgₓ)₂P₂O₇:Eu (0≦x≦1), (Ba₁₋ₓSrₓ)MgAl₁₀O₁₇:Eu (0≦x≦1), (Ba₁₋ₓSrₓ)MgAl₁₀O₁₇:Eu,Co (0≦x≦1), (Ba₁₋ₓSrₓ)₅(PO₄)₃(F,Cl):Eu (0≦x≦1), (Ba_{1-x-y}SrₓCa_{y})₅(PO₄)₃(F,Cl):Eu (0≦x≦1, 0≦y≦1), Y₂SiO₅:Ce, or ZnS:Ag.

In all embodiments, the following may be used as a luminescent material for green color segments, for example: (Ba₁₋ₓSrₓ)MgAl₁₀O₁₇:Eu,Mn (0≦x≦1), ZnS:Cu,Al,Au, SrGa₂S₄:Eu, or Gd₂O₂S:Tb.

In all embodiments the following may be used as a luminescent material for red color segments, for example: Y₂O₃:Eu,Bi, YVO₄:Eu, Y(V₁₋ₓPₓ)O₄:Eu (0≦x≦1), Y₂O₂S:Eu, Mg₄GeO_{5.5}F:Mn, or (Y₁₋ₓGdₓ)₂O₃:Eu,Bi (0≦x≦1).

All these luminescent materials may be efficiently excited with UV light with a wavelength of >172 nm, in particular by UV light in a wavelength range of between 180 and 400 nm, and have short decay times (≦3.5 ms) after excitation with UV light.

To improve the stability and the surface properties, for example the zeta potential, the sputter resistance, or the secondary electron emission of the luminescent materials, they may have a coating of a material which is transparent to radiation 10 in the wavelength range of the plasma discharge, i.e. to radiation 10 with a wavelength of >172 nm. The material used for the coating may be for example: Ca₂P₂O₇, MgO, MgAl₂O₄, B₂O₃, Al₂O₃, Sc₂O₃, Y₂O₃, La₂O₃, CaO, Gd₂O₃, Lu₂O₃, AlPO₄, ScPO₄, YPO₄, LaPO₄, GdPO₄, LuPO₄, AlBO₃, ScBO₃, YBO₃, LaBO₃, GdBO₃, or LuBO₃. The coating may be a coating of the individual particles of luminescent material or a layer which covers the layer containing a luminescent material.

A coating of the particles of luminescent material or the covering of the additional layers 14, 19 with a coating also has the advantage that uniform plasma cells are obtained, because no interactions occur between luminescent material and plasma. As a result, the electrical margins within which a plasma picture screen of this type may be operated are wider.

To produce a dielectric layer 4, 17 which contains luminescent materials, a luminescent material is mixed with the starting material used to produce the dielectric layer 4, 17. The starting material may be a glass material or a ceramic material. The dielectric layer 4, 17 may contain one or more oxides selected from the group Li₂O, Na₂O, K₂O, SiO₂, B₂O₃, BaO, Al₂O₃, ZnO, MgO, CaO and PbO mixed with a luminescent material.

To produce a dielectric layer 4, 17 which contains luminescent materials, first three screen-printing pastes are produced with the same percentage by weight of the screen-printing paste base and the glass material or the ceramic material. The screen-printing paste base is preferably p-menth-1-en-8-ole with 5% by weight of ethylcellulose. Then three luminescent material pastes are produced from the screen-printing paste base and 70 parts by weight of a red-emitting, green-emitting or blue-emitting luminescent material, respectively. Then a screen-printing paste is mixed in a ratio of 10:1 with each luminescent material paste. The pastes obtained are applied by means of screen printing in a structured way to the front plate 1 or the carrier plate 2, so that a segmented dielectric layer 4, 17 made of vertical luminescent material triplets is formed. The dielectric layer 4, 17 is dried and then the entire front plate 1 is exposed to a temperature of 485° C. The layer thickness of the finished dielectric layer 4, 17 is preferably between 20 and 40 μm.

To produce an additional layer 14, 19, first three suspensions each with one of the three luminescent materials is applied to the front plate 1 or the carrier plate 2 by means of a printing process, a doctor blade process, or a spin coating process and then dried.

A suspension applied by means of spin coating to the front plate 1 or to the carrier plate 2 preferably contains a low concentration of dissolved auxiliary agents, for example organic polymeric binders such as polyvinyl alcohol. The composition of the individual suspensions of the luminescent materials should therefore advantageously be chosen such that the dissolved content is not more than 20% by volume of the luminescent materials. It is advantageous to limit the volume ratio of luminescent material to binder to 10:1.

If the layer containing a luminescent material is a protective layer 5, 18, first three suspensions with MgO and one luminescent material each are produced and applied to the front plate 1 or the carrier plate 2 by means of a printing process, doctor blade process, or spin coating process and then dried.

The further production steps to produce of plasma picture screen according to the invention are performed using known methods and procedures.

1. A plasma picture screen provided with a front plate (1) comprising a transparent plate (3) on which a first dielectric layer (4) and a first protective layer (5) are applied, with a carrier plate (2), with a ribbed structure (11) which divides the area between the front plate (1) and the carrier plate (2) into plasma cells which are filled with a gas, and with one or more electrode arrays (6, 7, 9, 15, 16) on the front plate (1) and the carrier plate (2) for the generation of corona discharges in the plasma cells, whereby UV light with a wavelength of >172 nm is generated, wherein the front plate (1) has a first layer containing a luminescent material on the side facing the plasma cells.

2. A plasma picture screen as claimed in claim 1, characterized in that the first layer containing a luminescent material is the first dielectric layer (4).

3. A plasma picture screen as claimed in claim 1, characterized in that the first layer containing a luminescent material is the first protective layer (5).

4. A plasma picture screen as claimed in claim 1, characterized in that the layer containing a luminescent material is an additional layer (14).

5. A plasma picture screen as claimed in one of the claims 1 to 4, characterized in that the carrier plate (2) on the side facing the plasma cells has a second layer containing a luminescent material.

6. A plasma picture screen as claimed in claim 5, characterized in that the second layer containing a luminescent material is a second dielectric layer (17).

7. A plasma picture screen as claimed in claim 5, characterized in that the second layer containing a luminescent material is an additional layer (19).

8. A plasma picture screen as claimed in claim 5, characterized in that the second layer containing a luminescent material is a second protective layer (18).
